(19) United States
(12) Patent Application Publication
(10) Pub. No.: US 2026/0029847 A1
(43) Pub. Date: Jan. 29, 2026

(54) SEMI-DRY ELECTRODE ASSEMBLY, EEG DEVICE AND SYSTEM FOR BRAIN-COMPUTER INTERFACE

(71) Applicant: ACADEMIA SINICA, Taipei (TW)

(72) Inventors: Yu Te WANG, Taipei City (TW); Jui-Bang LU, Taoyuan City (TW); Yu-Jung SU, Tainan City (TW)

(21) Appl. No.: 19/031,333

(22) Filed: Jan. 17, 2025

Related U.S. Application Data
(60) Provisional application No. 63/622,190, filed on Jan. 18, 2024.
(60) Provisional application No. 63/623,246, filed on Jan. 20, 2024.
(60) Provisional application No. 63/673,154, filed on Jul. 18, 2024.

(51) Int. Cl. G06F 3/01

(52) U.S. Cl. CPC G06F 3/015

(57) ABSTRACT

A semi-dry electrode assembly is disclosed, it comprises: a case having a container and an opening; and an electrode disposed in the container, comprising: a shaft, rotatably mounted on the case; and a protrusion structure on the shaft, wherein at least one part of the protrusion structure protrudes through the opening from the container.

### CROSS-REFERENCE TO RELATED INVENTION

This patent application claims the benefit of U.S. Provisional Application No. 63/622,190 filed Jan. 18, 2024 and the disclosure is incorporated herein by reference in its entirety, claims the benefit of U.S. Provisional Application No. 63/623,246 filed Jan. 20, 2024 and the disclosure is incorporated herein by reference in its entirety, claims the benefit of U.S. Provisional Application No. 63/673,154 filed Jul. 18, 2024 and the disclosure is incorporated herein by reference in its entirety.

### FIELD OF INVENTION

The present description relates to a semi-dry electrode assembly, an electroencephalography (EEG) device and system for Brain-Computer Interface (BCI).

### BACKGROUND

Wet electrodes with conductive gel are widely used for recording electroencephalography (EEG) signals due to their low impedance between the scalp and the electrode. However, their extensive preparation time before data collection and the required cleaning afterward make them impractical for real-world Brain-Computer Interface (BCI) applications. Semi-dry electrodes present an alternative approach for continuous EEG monitoring in comparison to dry electrodes. Users can put on the semi-dry electrodes themselves without any professional help. However, the trade off between hair-layer penetration and dose control of conductive material is challenging. An improved semi-dry electrode is needed.

### SUMMARY

The disclosure provides a semi-dry electrode assembly comprising: a case having a container and an opening; and an electrode disposed in the container, comprising: a shaft, rotatably mounted on the case; and a protrusion structure on the shaft, wherein at least one part of the protrusion structure protrudes through the opening from the container.

The disclosure provides an electroencephalography (EEG) device comprising a plurality of the semi-dry electrode assemblies, wherein the semi-dry electrode assembly comprises: a case having a container and an opening; and an electrode disposed in the container, comprising: a shaft, rotatably mounted on the case; and a protrusion structure on the shaft, wherein at least one part of the protrusion structure protrudes through the opening from the container.

The disclosure provides a system for brain-computer interface (BCI) comprising: an EEG device comprising a plurality of the semi-dry electrode assemblies, wherein the semi-dry electrode assembly comprises: a case having a container and an opening; and an electrode disposed in the container, comprising: a shaft, rotatably mounted on the case; and a protrusion structure on the shaft, wherein at least one part of the protrusion structure protrudes through the opening from the container; an amplifier coupled to the semi-dry electrode assemblies of the EEG device; and a computing device coupled to the amplifier and configured to process signals received by the amplifier as a user input.

### BRIEF DESCRIPTION OF DRAWINGS

In order to sufficiently understand the essence, advantages and the preferred embodiments of the present invention, the following detailed description will be more clearly understood by referring to the accompanying drawings.

FIGS. 1A-1B illustrate a semi-dry electrode assembly according to some embodiments.

FIGS. 1C-1D illustrate the electrode of the semi-dry electrode assembly in FIG. 1A.

FIGS. 2A-2B illustrate a semi-dry electrode assembly according to some embodiments.

FIGS. 2C-2D illustrate the electrode of the semi-dry electrode assembly in FIG. 2A.

FIGS. 3A-3B illustrate a semi-dry electrode assembly according to some embodiments.

FIGS. 3C-3D illustrate the electrode of the semi-dry electrode assembly in FIG. 3A.

FIGS. 4A-4B illustrate the case of the semi-dry electrode assembly with spring according to some embodiments.

FIGS. 4C-4D illustrate the semi-dry electrode assembly of FIG. 1A with spring according to some embodiments.

FIGS. 4E-4F illustrate the semi-dry electrode assembly of FIG. 2A with spring according to some embodiments.

FIGS. 4G-4H illustrate the semi-dry electrode assembly of FIG. 3A with spring according to some embodiments.

FIG. 5 illustrates the CAD models for the ProfSP and ProfST electrodes. (Right) Side view of the proposed electrode. The model has support legs (silver parts) to prevent deformation during the LCD printing.

FIG. 6 illustrates fabrication of the proposed 3D-printing EEG electrodes. From left to right, the wheel for ProfST (top) and ProfSP, wheel and reservoir assembled, coated with Ag/AgCl, and connected with EEG amplifier. A snap button is placed at the right-down corner.

FIG. 7 illustrates Time domain EEG traces for two participants. They are asked to close eyes (0-7 seconds), blink eyes (around 7-10 seconds), and open eyes (around 10-16 seconds). Note the data are recorded in different time. Also, ProfSP and ProfST-ProfSP are manually shifted −100 and −200 μv for better visualization.

FIG. 8 illustrates welch power spectral density estimate for 3 participants. One minute EEG is used with 50% overlap, Hamming window, and 500 samples.

FIG. 9A illustrates front view. From left to right: straight roller, spiral roller, star roller, springer, and reservoir.

FIG. 9B illustrates top view. From left to right: straight roller, spiral roller, star roller, springer, and reservoir.

FIG. 9C illustrates front view and side view of components.

FIG. 9D illustrates three types of rollers: straight, spiral and star.

FIG. 10 illustrates applying gel by gently brushing through the hair.

FIG. 11 illustrates experimental setup for measuring the pressing force required for three electrodes to achieve a stable impedance of 30 kΩ on the artificial skin. The artificial skin is prepared using a mixture of water, gelatin, and sodium chloride, cooled to form a stable impedance medium.

FIG. 12 illustrates Analyze the press force required to measure 40 KΩ on the electrodes.

FIG. 13 illustrates Impedance performance of different profiles at different frequencies.

FIG. 14 illustrates examples of the three electrode designs penetrating slightly curly hair.

FIG. 15 illustrates Gel Consumption: The Signagel Electrode Gel is labeled as “green,” while the NUPREP Skin Prep Gel is labeled as “blue.”

FIG. 16 illustrates EEG Summary of Participant No. 1: Left: Timedomain EEG signals recorded under eyes-open and eyesclosed conditions. Middle: FFT plot of the averaged EEG signals from the O1, Oz, and O2 channels. Right: SSVEP response amplitude at 10 Hz

FIG. 17 illustrates Summary of Electrode Profile Advantages Across Different Hair Types.

FIG. 18 illustrates Power Spectral Density (PSD) across different conditions and electrode types. The first row shows PSD results for SSVEP 10 Hz conditions, the second row for close eye conditions, and the third row for open eye conditions. Each column corresponds to a specific electrode type: straight (a, d, g), spiral (b, e, h), and star (c, f, i). Group-level averages and overall averages are presented for each condition.

FIG. 19A illustrates TABLE I: Spec of conductive gels.

FIG. 19B illustrates TABLE II: The characteristics of the 15 participants, including their hair properties, are summarized. There are 8 hair types, as defined in Table. III.

FIG. 19C illustrates TABLE III: Types of wigs used for functional testing.

### DETAILED DESCRIPTION

The following description shows the preferred embodiments of the present invention. The present invention is described below by referring to the embodiments and the figures. Thus, the present invention is not intended to be limited to the embodiments shown, but is to be accorded the principles disclosed herein. Furthermore, that various modifications or changes in light thereof will be suggested to persons skilled in the art and are to be included within the spirit and purview of this application and scope of the appended claims.

Semi-dry electrodes act as the middle ground between wet and dry electrodes as they not only have similar contact features (equivalent circuit) with wet electrodes but also carry the conduct material in their cavity or sponge (e.g. absorb saline water) for long-term brain-computer interface (BCI) applications. However, the trade off between hair layer penetration and dose control of conductive material is challenging. For example, two electrodes might be bridged when the headset continuously presses or squeezes the reservoir and electrolyte flows on the scalp.

The form factor of the semi-dry electrodes can be designed to separate the hair so electrodes can make good contact with the scalp. Also, by pressing or squeezing the reservoir, the conductive material is released and the electric contact between electrodes and the scalp is established.

The disclosure provides a semi-dry electrode assembly with protrusion structure (e.g. watermill-like shape or multi-tip shape, etc.) which has capability of hair layer penetration and dose control of conductive material. The semi-dry electrode assembly comprises a case and an electrode. The case has a container and an opening. The electrode is disposed in the container and comprises a shaft and a protrusion structure. The shaft is rotatably mounted on the case. The protrusion structure is on the shaft. At least one part of the protrusion structure protrudes through the opening from the container. The case is configured to hold the electrode in the container. A shape of the container fits with a contour or an envelope of the electrode.

At least one of two ends of the shaft is rotatably mounted on the case within the container. For example, one end of the shaft is rotatably mounted on the case by structure shape or friction between the shaft and the case.

The semi-dry electrode assembly could be an electroencephalography (EEG) electrode used for an EEG device and a system for brain-computer (BCI) interface. The EEG device may be a head-mounted display (HMD) device, a pair of glasses, a headphone, an earbud, a watch, or an activity band. The EEG device may comprise a preamplifier. The system for BCI may comprise an EEG device, an amplifier coupled to the semi-dry electrode assemblies of the EEG device, and a computing device coupled to the amplifier and configured to process signals received by the amplifier as a user input.

A method for operating the semi-dry electrode assembly comprises providing an EGG device; moving the EGG device by rolling the electrode of the semi-dry electrode assembly in contact with a user skin such that the electrode rotates in the container thereby delivering the conductive material from the container to the user skin; and detecting an electrical potential from the semi-dry electrode assemblies. The electrical potential can be an input to electroencephalography (EEG), an electrocardiogram (ECG), or electromyography (EMG).

The semi-dry electrode assembly can use a minimal or as less as possible amount of conductive material and achieve a comparable signal-to-noise quality to wet electrodes. Without help from skilled technicians, the self-wearing mechanical design allows users to wear and acquire their EEG electrodes in few minutes. In some embodiments, the container of the semi-dry electrode assembly could be a refillable reservoir enables the possibility for long-term BCI applications. In some embodiments the semi-dry electrode assembly can read neural activities on the hair-covered area. The electrodes with protrusion structure (e.g. watermill-like shape, etc.) can shorten the preparation time as well as the dose control of conductive material for naive users.

In some embodiments, the electrode of the semi-dry electrode assembly may be a wheel or roller which is rotatable. The container of the semi-dry electrode assembly could be a reservoir.

In some embodiments, the case of the semi-dry electrode assembly is conductive and it may be Ag/AgCl-based case. The case can be coated with conductive material or can be formed from conductive material. The case can have a non-conductive core coated with conductive material on the surface of the core. The conductive material for the case, for example, may be silver/silver chloride.

In some embodiments, the electrode of the semi-dry electrode assembly is conductive. The electrode can be coated with conductive material or can be formed from conductive material. The electrode can have a non-conductive core coated with conductive material on the surface of the core. The conductive material for the electrode, for example, may be silver/silver chloride.

In some embodiments, the conductive material filled in the container of the semi-dry electrode assembly may be a conductive gel, e.g. chloride gel.

In some embodiments, the protrusion structure comprises protrusions and at least one groove. The protrusion is beside the groove, and the groove is between the protrusions. The protrusion may be a fin, rib, ridge, disk, flange, cap, tip, etc. The electrodes with protrusion structure may have watermill-like shape, for example straight line shape, gear shape, spiral track shape, multi-tip shape, etc. The multi-tip shape may be star wheel shape. The spiral-shaped electrode is configured to comb hair to one side. The star-wheel-shaped electrode (or called star electrode) is configured for curly hair to ensure enhanced scalp contact, thereby improving signal quality during electrode application. The star-wheel-shaped electrode is configured for direct penetration through hair.

In some embodiment, the shaft and the case of the semi-dry electrode assembly could be made from an integrated piece during fabrication, while the spring cap is made separately. After fabrication, the shaft and the case are individual component. In some embodiment, the shaft, the case and the spring cap of the semi-dry electrode assembly could be made separately.

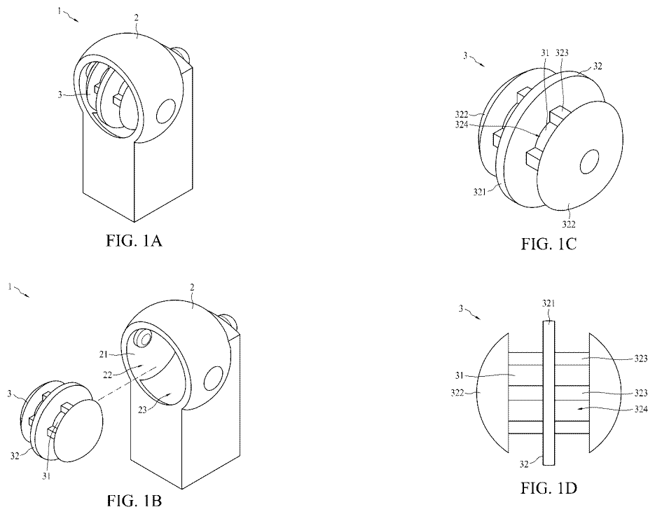

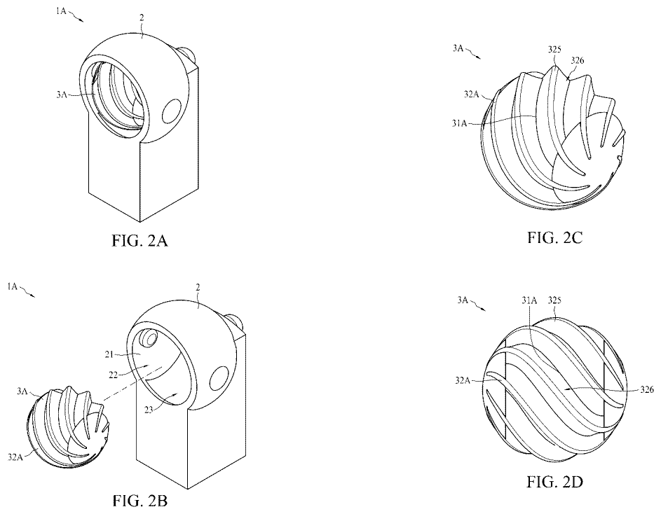

FIGS. 1A-1B illustrate a semi-dry electrode assembly according to some embodiments. FIGS. 1C-1D illustrate the electrode of the semi-dry electrode assembly in FIG. 1A. In FIGS. 1A-1B, a semi-dry electrode assembly 1 comprises a case 2 and an electrode 3. The case 2 has a container 21 and an opening 22. The electrode 3 is disposed in the container 21 and comprises a shaft 31 and a protrusion structure 32. The shaft 31 is rotatably mounted on the case 2. The protrusion structure 32 is on the shaft 31. At least one part of the protrusion structure 32 protrudes through the opening 22 from the container 21.

The case 2 comprises a passage 23 which could be an auxiliary container or reservoir configured to contain the conductive material. The passage 23 is connected with the containing space of the container 21. For example, the conductive material could be contained in the container 21 and the passage 23 and on the plate 43. In another embodiment, the case 2 may not comprise the passage 23.

The protrusion structure 32 comprises protrusions 321-323 and grooves 324. The protrusion is beside the groove, and the groove is between the protrusions. The protrusions 321-323 are configured to face the opening 22 and a surface 211 of the container 21 alternatively during a rotation of the electrode 3. The grooves 324 are configured to face the opening 22 and the surface 211 of the container 21 alternatively during the rotation of the electrode 3. The container 21 is configured to contain a conductive material, and the protrusion structure 32 is configured to take out the conductive material from the container 21 to the opening 22 during the rotation of the electrode 3.

A part of the electrode 3 is submerged with the conductive material in the container 21, so a lateral surface and/or a front surface of the protrusion can carry or dip the conductive material. The electrode 3 is configured to pull and dispatch the conductive material on a scalp or a skin during the rotation of the electrode 3. At least one of the protrusions 321-323 is configured to drag the conductive material in at least one of the grooves 324 or on a surface of the at least one of the protrusions 321-323. Thus, the conductive material can be transferred from the container 21 into the groove or onto the protrusion.

The shaft 31 is configured to rotate in the container 21 to cause the conductive material to be carried or dipped in at least one groove 324 by the electrode 3. The carried or dipped conductive material is applied on the scalp or the skin when the at least one groove 324 faces the opening 22 during the rotation so that the carried or dipped conductive material is delivered from the container 21 to the scalp or the skin.

The shaft 31 is configured to rotate in the container 21 to cause the conductive material to be carried or dipped by at least one of the protrusions 321-323. The carried or dipped conductive material is applied on the scalp or the skin when at least one of the protrusions 321-323 (e.g. protrusion 321 or 322) protrudes through opening during the rotation so that the carried or dipped conductive material is delivered from the container 21 to the scalp or the skin.

The protrusions 321-322 are configured to penetrate a hair layer and reach the scalp or the skin. The grooves 324 are configured to accommodate or comb hairs when the electrode 3 is rolled on the scalp or the skin.

Two ends of the shaft 31 are rotatably mounted on the case 2 within the container 21, and the protrusion structure 32 is between the two ends of the shaft 31. In some alternative embodiments, only one end of the shaft 31 is rotatably mounted on the case 2 within the container 21, and the other end of the shaft 31 is free end. A rotating axis of the shaft 31 is configured to be cross hairs. The shaft 31 is rotatable with respect to the rotating axis and configured to roll along the hairs. A releasing amount of the conductive material from the container 21 to the scalp or the skin is controlled by the rotation.

The conductive material can be prevented from leakage when the electrode 3 is pressed by a headband/stripe. When the electrode 3 is tightened with a headband or a stripe or an element on the scalp or the skin, the electrode 3 is not rotated and a dispensation of the conductive material from the container 21 to the scalp or the skin is stopped.

A maximum diameter of the electrode 3 can be about 5-20 millimeters, for example, 10, 11, 12, 13, 14, or 15 millimeters. A length of the electrode 3 is about 10-20 millimeters, for example, 10, 11, 12, 13, 14, or 15 millimeters. The electrode 3 has two tips at its two end portions or caps, and each tip is about 2.5 millimeters. The tips are protrusions 322.

In some embodiments, the protrusion structure may have various patterns or shape. In FIGS. 1A-1D, the protrusion structure comprises straight protrusions. The protrusions 321-322 are straight line shape on and cross the shaft 31. The protrusion 321 can be a flange or disk around the shaft 31 or consists of fins around the shaft 31. The protrusions 322 can be cap or disk at two ends of the shaft 31. The protrusions 323 are ribs on the shaft 31 connected between the protrusions 321-322. The protrusions 323 are parallel with the shaft 31. The height of the protrusions 323 from the shaft 31 are lower than the heights of the protrusions 321-322 from the shaft 31. The heights of the protrusions 321-322 from the shaft 31 are high enough for the protrusions 321-322 to protrude from the opening 22 when facing the opening 22. The height of the protrusions 323 from the shaft 31 may be or may not be high enough for the protrusions 323 to protrude from the opening 22 when facing the opening 22.

The grooves 324 are defined by the protrusions 321-323. In one example, the grooves 324 expose the shaft 31, so the conductive material can be carried in the groove 324 by the shaft 31 and the protrusion beside the groove 324. The protrusions 321-323 may have slope or vertical surfaces. In another example, the protrusion may have slope surface and the grooves 324 do not expose the shaft 31, so the conductive material can be carried in the groove 324 by the protrusion beside the groove 324.

FIGS. 2A-2B illustrate a semi-dry electrode assembly according to some embodiments. FIGS. 2C-2D illustrate the electrode of the semi-dry electrode assembly in FIG. 2A. In FIGS. 2A-2D, the electrode 3A of the semi-dry electrode assembly 1A comprises spiral-shaped protrusions. The protrusion structure 32A comprises protrusions 325 and grooves 326. The protrusions 325 are spiral-shaped protrusions, and the grooves 326 are spiral tracks.

The protrusion 325 can be a ridge around the shaft 31A or consists of fins around the shaft 31. The height of the protrusion 325 from the shaft 31A is high enough for the protrusion 325 to protrude from the opening 22 when facing the opening 22.

The grooves 326 are defined by the protrusions 325. In one example, the grooves 326 expose the shaft 31A, so the conductive material can be carried in the groove 326 by the shaft 31A and the protrusion 325 beside the groove 326. The protrusions 325 may have slope or vertical surfaces. In another example, the protrusion may have slope surface and the grooves 326 do not expose the shaft 31A, so the conductive material can be carried in the groove 326 by the protrusion 325 beside the groove 326.

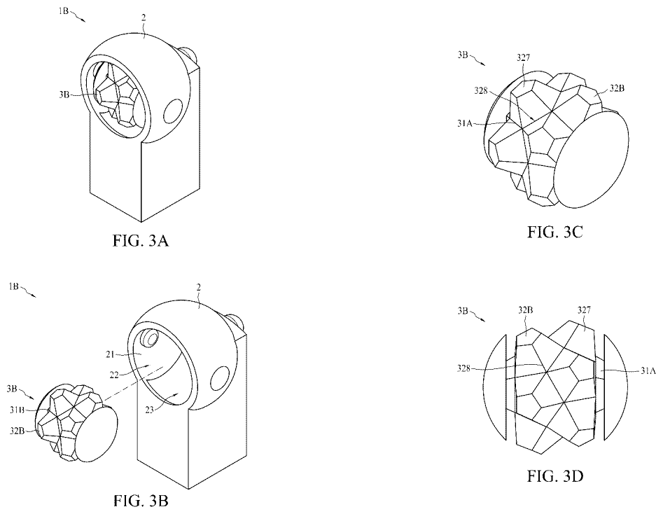

FIGS. 3A-3B illustrate a semi-dry electrode assembly according to some embodiments. FIGS. 3C-3D illustrate the electrode of the semi-dry electrode assembly in FIG. 3A. In FIGS. 3A-3D, the electrode 3B of the semi-dry electrode assembly 1B comprises multi-tip shape. The protrusion structure 32B comprises protrusions 327 and grooves 328. The protrusions 327 are tip-shaped protrusions, and the grooves 328 are valley. The height of the protrusion 327 from the shaft 31B is high enough for the protrusion 327 to protrude from the opening 22 when facing the opening 22.

The grooves 328 are defined by the protrusions 327. In one example, the grooves 328 expose the shaft 31B, so the conductive material can be carried in the groove 328 by the shaft 31B and the protrusion 327 beside the groove 328. The protrusions 328 may have slope or vertical surfaces. In another example, the protrusion may have slope surface and the grooves 328 do not expose the shaft 31B, so the conductive material can be carried in the groove 328 by the protrusion 327 beside the groove 328.

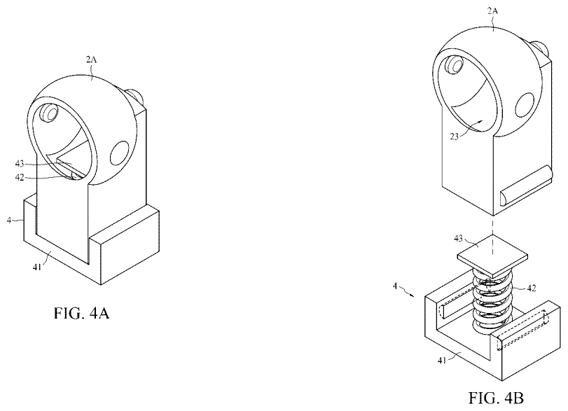

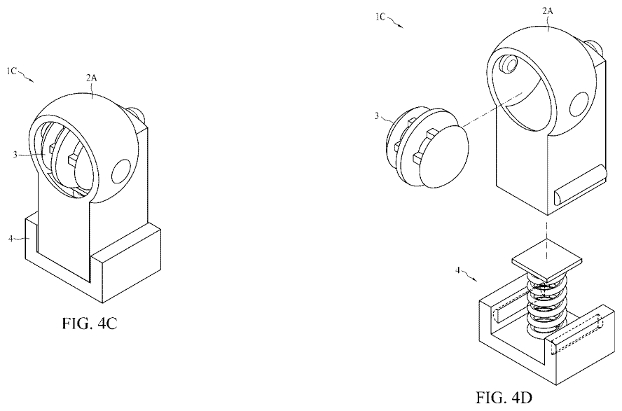

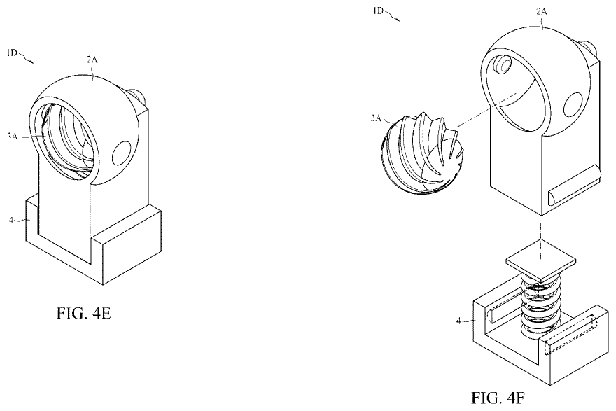

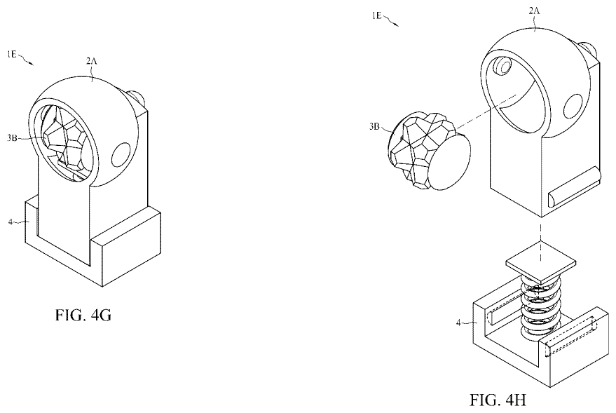

FIGS. 4A-4B illustrate the case of the semi-dry electrode assembly with spring according to some embodiments. The semi-dry electrode assembly can further comprise a spring cap structure 4. In FIGS. 4A-4B, the electrode is not shown to illustrate the assembling of the case 2A with spring cap structure 4. The spring cap structure 4 comprises a cap 41, a spring 42 and a plate 43. The cap 41 is assembled with the case 2A or disposed atop the container. One end of the spring 42 is mounted on the cap 41, and the other end of the spring 42 is toward the shaft of the electrode. The plate 43 is on the other end of the spring 42 and toward the shaft of the electrode.

The case 2A comprises a passage 23 which could be an auxiliary container or reservoir configured to contain the conductive material. The spring 42 and the plate 43 are arranged along the passage 23. The spring 42 is compressed or stretched in the passage 23 to move the plate 43 along the passage 23. The spring cap structure 4 functions as a spring-loaded gel dispenser.

Upon injection of the conductive material and subsequent closure of the cap 41, the spring 42 is compressed to counteract a resistance force exerted by the conductive material until equilibrium is reached. As the conductive material is consumed and the resistance force is diminished, the spring's restoring force then extrudes the conductive material from the container 21 to the electrode until reaching another equilibrium. For example, the conductive material could be contained in the container 21 and the passage 23 and on the plate 43. The plate 43 is moved by the spring 42 to extrude the conductive material from the container 21 to the electrode.

The spring 42 is configured to be adjustable to suit conductive materials with different viscosity. The spring 42 may be a coiled spring, and a wire diameter of the spring and a number of active coils of the spring depend on the size and weight of the electrode. The design of the spring depends on the viscosity of the conductive material. For example, the viscosity of the conductive material may be between 200-500000 (cP), for example, between 200-1000 (cP) or between 160000-300000 (cP). A critical force for the conductive material is between 0.05-0.4 (N). The outer diameter of the spring is between 5-8 (mm).

FIGS. 4C-4D illustrate the semi-dry electrode assembly of FIG. 1A with spring according to some embodiments. In FIGS. 4C-4D, the semi-dry electrode assembly 1C comprises the case 2A, the electrode 3 and the spring cap structure 4.

FIGS. 4E-4F illustrate the semi-dry electrode assembly of FIG. 2A with spring according to some embodiments. In FIGS. 4E-4F, the semi-dry electrode assembly 1D comprises the case 2A, the electrode 3A and the spring cap structure 4.

FIGS. 4G-4H illustrate the semi-dry electrode assembly of FIG. 3A with spring according to some embodiments. In FIGS. 4G-4H, the semi-dry electrode assembly lE comprises the case 2A, the electrode 3B and the spring cap structure 4.

Due to the spring cap structure 4 with the spring 42, the semi-dry electrode assembly could overcome the bottlenecks of hair penetration and dose control simultaneously. The spring-loaded gel dispenser and a watermill-like roller that evenly distributes the conductive material across the electrode surface. As the roller rotates, it scopes a small amount of conductive material and applies to its traveling path. This design could prevent the case of overdosing when extra force is applied on the proposed electrodes, which allows users to wear the electrodes and record EEG signals by simply brushing their hair, eliminating the need for assistance from skilled technicians.

### Experiment 1

Fused Decomposition Modeling (FDM) with Polylactic Acid material is used for the structure testing, and Liquid Crystal Display (LCD) with resin is used for the functional prototyping. In the structure testing, the goals are: (1) Validate the feasibility of the straight and spiral wheel profiles, named ProfST and ProfSP, respectively. (2) Evaluate two wheel profiles in terms of the hair layer penetration. In the functional prototyping, the goals are: (1) validate the performance of dosing conductive material; and (2) evaluate the neural response performance after coating with Ag/AgCl on the proposed electrodes.

### A. Electrode Structure Design and Testing

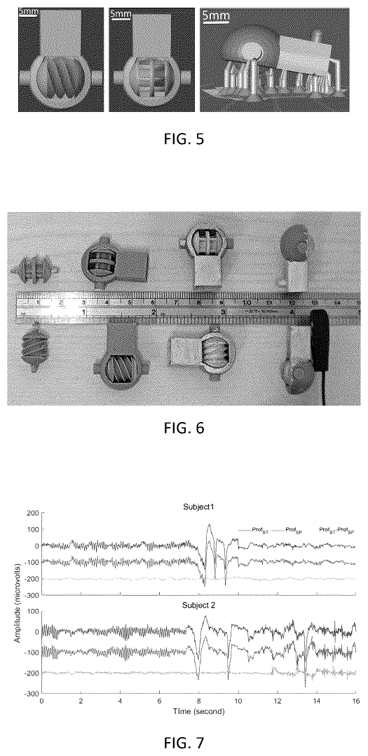

FIG. 5 shows the CAD model of the proposed electrodes. It consists of a multi-thread wheel and a reservoir. The wheel with a tongue sticking out for position locking on each side. The ProfST electrode has four orthogonal dividers against the main thread. The ProfSP electrode has 3 threads. The reservoir has two grooves on each side for holding the wheel, and a male-button protrusion connecting to an EEG amplifier. The reservoir has an opening so the crest of the wheel can contact with scalp. Users can refill the conductive material on the other side of the reservoir. Both ProfST and ProfSP could divide hair into the gaps between crests.

Both ProfST and ProfSP electrodes are pushed and pulled against different thicknesses of a female wig (25, 35, 45, and 55 mm) 3 CM and repeated 10 times. The number of crests (1-3), crest thickness (0.9 mm, 1.2 mm, 1.5 mm), distance between pitch (1.55 mm, 2.07 mm, 3.25 mm), and tooth depth (1 mm, 2 mm, 3 mm) are 3D printed and tested. The wheel designs for each electrode profile can be found in the previous embodiments.

### B. Electrode Functional Prototyping

The configurations (e.g. number of threads or root depth) are inherited from the structure testing. Then the electrodes will be 3D printed by a 4K resolution LCD printer. The fabrication process is as following:

Electrode modeling: printer with resin is used to print electrodes, followed by the postpolymerize process, such as cleaning (alcohol) and curing (ultra light). Blender is used for the modeling while Chitubox is for slicing. The whole electrodes are tilted and printed in one piece with a supportive design to prevent the collapse, as shown in FIG. 1 (right). The printing process took approximately 1.5 hours for 12 electrodes.

Electrode coating: Ag/AgCl (60/40) conductive paste is applied on the electrodes after the modeling process. A heat gun is used (300 Celsius and 30 seconds) to solidify and evaporate the resin of the conductive paste on the electrode.

System assembling: Three conduct material with the viscosity of 350 cp, 168,550 cp, and 180,000-260,000 cp are chosen to test the performance of applying conductive material with ProfST and ProfSP on the scalp. An EEG amplifier is connected to the snap button interface to record the EEGs. Finally, an elastic headband is used to secure the electrodes on the head. Experimenters continuously monitor the headset to see if there is any leakage from proposed electrodes.

### C. EEG Study: Participant, Equipment, Experimental Design, and Data Pre-Processing

4 participants joined this test (all male). They are seated on an arm chair facing a 15.6 inch LCD monitor with 70 CM distance. Two electrodes are attached around Oz area (O1 with ProfST while O2 with ProfSP) and secured by an elastic headband. Participants pushed and pulled the electrodes filled with Signagel Electrode Gel on their head 5 times (around 3 CM distance in each iteration). The impedance for both channels are recorded. The experiment is consisted of 3 sessions and repeated 3 times, each session took 1 minute and there is a 30 seconds break in between. In the first session, participants are asked to try not blink their eyes and stare at a red cross (around 1 CM wide and tall) on the screen for 1 minute. In the 2nd session, participants are asked to close their eyes for 1 minute. In the third session, a 10 Hz flickering square is presented in the center of the screen for another 1 minute. The experimental time took around 20 minutes in total.

A laptop equipped with an NVIDIA GeForce RTX 4060 laptop GPU and 16 GB of RAM is used to present the visual stimulus. The onset events and EEGs are recorded by Labstreaminglayer. EEG amplifier is set at 500 Hz sampling rate and connected with the button interface shown in FIG. 6. The recorded EEGs are filtered by a notch filter (remove 60 Hz line noise), a band-pass filter (1-50 Hz), and all data are re-referenced to a channel on the forehead (around Fp1). Note that one participant is excluded from this study as they cannot stop blinking eyes during SSVEP session.

### Results: A. Hair-Layer Penetration and Gel Applying

FIG. 4 shows the hair penetration on a wig with ProfST and ProfSP electrodes. After 10 times brushing on the wig, both electrodes can separate and penetrate 25 mm and 35 mm hair thickness. In 45 mm thickness, ProfST can separate and penetrate the hair successfully, yet ProfSP can separate hair. The ProfST has larger space in the root (3 mm wide and 3 mm depth) to collect hair while ProfSP has less space due to the depth of threads (1 mm wide and 1 mm depth). FIG. 4 (right column) shows the results after applying the conductive material on the electrodes and brushing the hair 10 times. Most of the conductive material are applied on the hair for the ProfSP electrode (bottom) while the ProfST electrode successfully divides the hair into roughly three clusters and conductive material are filled in the gaps.

### Results: B. EEG Signal Evaluation

FIG. 7 shows the EEG recordings for 2 participants. The alpha-band spindles are observed in both ProfST and ProfSP when participants closed their eyes from 0-7 seconds, followed by eyes blinked (7-10 seconds) and opened (10-15 seconds). For participant 1, the correlation between the ProfST and ProfSP electrodes are around 0.95 for 1-minute recording with impedance of 60 KΩ. For participant 2, the correlation between the ProfST and ProfSP electrodes are around 0.89 for 1-minute recording with the impedance is 60 KΩ and 70 KΩ, respectively. It seems the impedance might the reason causing the relatively low correlation between two electrode profiles i.e. EEG is noisy in the ProfSP electrode.

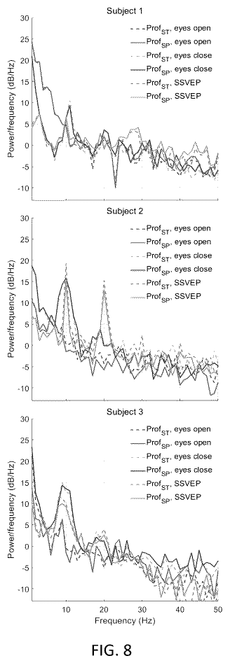

FIG. 8 shows the power spectral density for 3 participants (one is excluded due to too many eyes blinks in the SSVEP session). First, in all participants the alpha band peaks (11, 10, and 9 Hz) are observed for both electrode profiles when eyes closed, and the peaks disappeared in the eyes opened session. Second, the fundamental SSVEP response (10 Hz) is observed in both electrode profiles for participant 1 and 2. The 2nd, 3rd, and 4th harmonics are also observed in ProfSP electrode in participant 2. For participant 3, the fundamental SSVEP response seems to be overlapped with alpha band peaks, yet we can still see 2nd harmonic (around 20 Hz) for both electrode profiles. Third, the power difference between two electrode profiles is subtle, less than 5 dB difference is observed in participant 2 and 3. In sum, both ProfSP and ProfST can obtain clear alpha band activities as well as SSVEP responses for all participants. However, we might need more participants to conclude the performance between two electrode profiles.

The proposed watermill-like EEG electrode can overcome the dose control issue by translating the dosing mechanism from conventional pressing or squeezing to the watermill-like rotation. Similar to comb the hair, when the wheel rotates the thread can divide and collect the hair in its root while scoping and applying conductive material along its track. The results showed the ProfSP electrode with 3 threads, 1 mm tooth depth, can penetrate 35 mm thickness while the ProfST electrode with 1 crest, 3 mm tooth depth can penetrate 45 mm thickness of hair. It is worth noting that when three conduct material with varies viscosity (350 cp, 168,550 cp, and 180,000-260,000 cp) are tested, none of them had leakage in the electrode. Also, it is noticed that the viscosity of conductive material might not be accurate. That is, both profiles scope much conductive material in high viscosity (180,000-260,000 cp) than low viscosity (350 cp). The proposed design systematically tested and validated watermill-like electrodes by measuring the neurophysiological responses to demonstrate the feasibility and possibility of self-wearing userfriendly EEG electrodes design. Without the help from professional and skilled technicians, users can manipulate proposed electrodes to brush their hair and obtain good quality of EEGs in less than a minute.

### Experiment 2

### A. Electrode Design, Fabrication, and Assembly

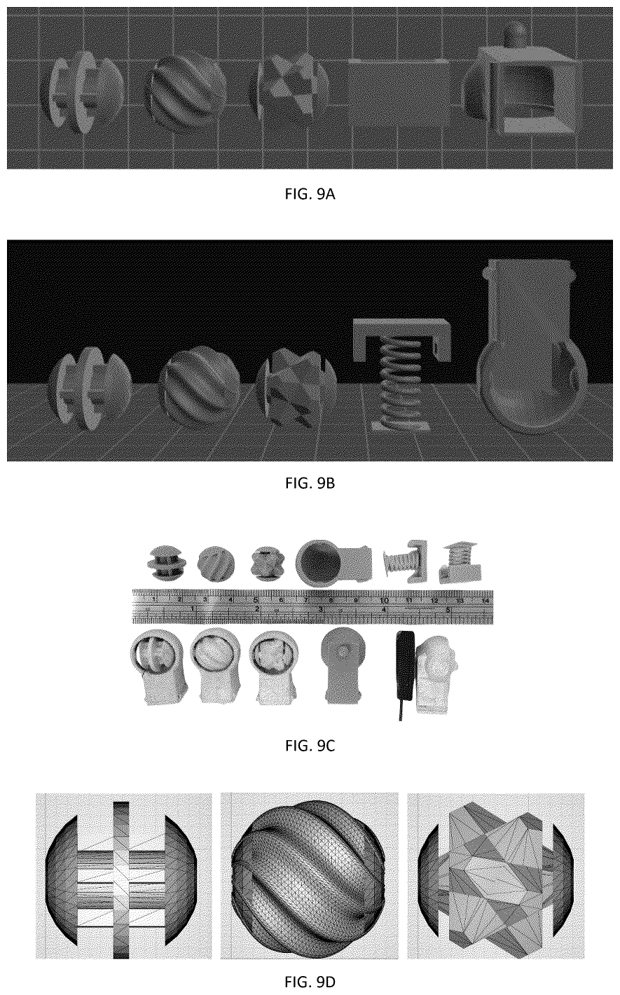

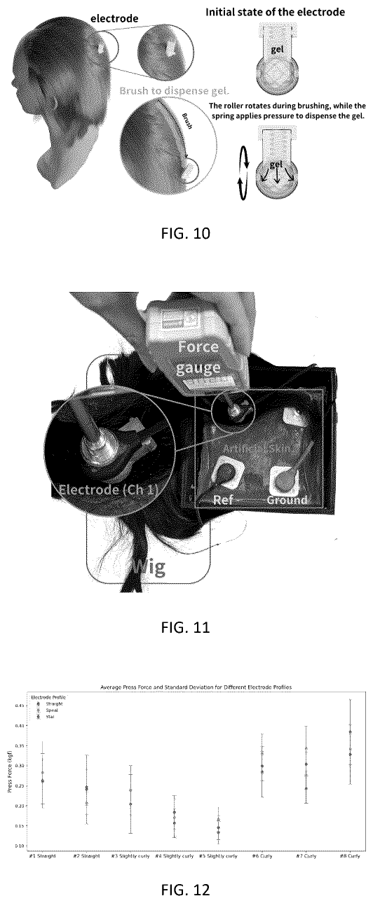

The watermill-shaped EEG electrode consists three components: a roller, a reservoir, and a spring-loaded cap, the models are shown in FIGS. 9A and 9B. The roller is enclosed within the reservoir, allowing it to rotate and facilitate the distribution of conductive gel while separating hair strands. Direct contact between the roller and the user's scalp ensures optimal signal transmission. This design enables EEG signals to be transmitted from the scalp through the roller to the container and ultimately to the amplifier for further signal processing. FIG. 10 shows the concept about how to apply the gel on the scalp. FIG. 9C shows the 3D-printed components with the LCD printer.

The proposed electrodes underwent a two-phase development process: a prototype phase followed by a functional evaluation phase. During the prototype phase, an ELEGOO Neptune 4 FDM 3D Printer is used to create initial models utilizing Fused Deposition Modeling (FDM). This technique, known for its speed and efficiency, is widely adopted for prototyping. The structural integrity and functionality of each electrode component are tested: the roller, reservoir, and cap. Specifically, the roller's ability to penetrate hair is verified, the reservoir's ability to apply conductive gel to the scalp during roller rotation is assessed, and the spring's functionality is evaluated to ensure proper compression and elasticity. In the functional evaluation phase, a Phrozen Sonic Mini 8K S Resin 3D Printer is employed. This printer utilizes Liquid Crystal Display (LCD) technology: a method offering superior resolution and detail compared to FDM at the cost of longer printing times. The final electrode prototypes, created during this phase, are designed to meet the precise requirements for functionality and appearance.

To ensure consistent quality, we standardized the printing process to keep electrodes in ideal condition. The electrodes are fabricated using an 8K-resolution Phrozen 3D printer with aqua-gray 4K resin, producing key components such as the roller, reservoir, and spring cap. After printing, components are cleaned with alcohol to remove residual resin, followed by a secondary UV curing process to complete hardening.

During fabrication, the roller and reservoir are designed as an integrated piece, while the spring cap is printed separately. To optimize printing accuracy and surface contact, all components are tilted during printing, with additional support structures added to prevent deformation, particularly on the reservoir edges and the spring's contact points. Each batch of prints requires approximately 2.5 hours, allowing for simultaneous production of up to six electrode sets, depending on the panel size. The spring on the cap is designed to apply consistent pressure on the conductive gel. As the gel on the roller is used, the spring compresses to maintain gel flow until the internal pressure and gel resistance reach equilibrium, ensuring a continuous supply of conductive gel during use. The spring rate is closely related to the gel's viscosity, as a stiffer spring can lead to excess gel extrusion, while a softer spring may fail to provide adequate pressure. To determine the optimal spring rate for different gels, we measured the critical force by placing the electrode on a scale and gradually applying pressure until gel reached the roller. This critical force helped us calculate the spring rate required for each gel type using Hooke's law.

With the target spring rate identified, the coil spring design is defined as:

$$k = \frac{{Gd}^{4}}{8 {N ( D - d )}^{3}} \qquad ( 1 )$$

where G is the material's shear modulus (fixed at 0.31 GPa), N is the number of active coils, d is the wire diameter (set to 1 mm), and D is the outer diameter of the coil. Given dimensional constraints, N and D are adjustable parameters; N is capped at 9 due to displacement limitations, and D must remain under 9.75 mm to fit the reservoir. Our design thus optimizes the balance of N and D for different gel viscosities. After fabrication, the electrodes are assembled to ensure efficient signal transmission from the scalp to the EEG device with minimal impedance. Since the LCD resin material is nonconductive, we applied a thin layer of silver chloride to the electrode surface to reduce impedance. Additionally, a snapbutton interface is printed onto the reservoir to establish a direct connection with the EEG amplifier. This setup allows the signal to travel seamlessly from the scalp through the conductive gel, roller, and reservoir, ultimately reaching the EEG device.

### B. Electrode Functional Testing and Performance Evaluation

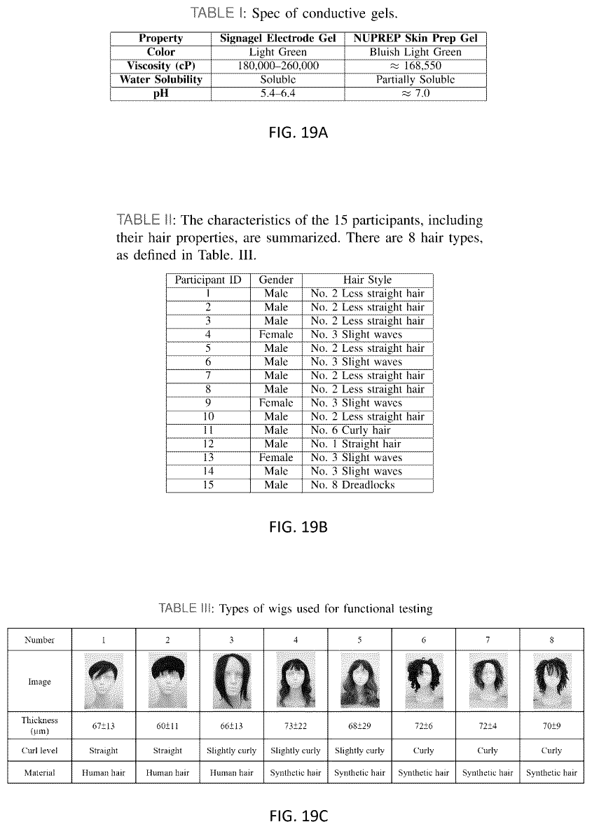

To verify whether our proposed electrodes can adapt to different hair types, we prepared wigs with various hair volumes and styles and designed different roller profiles accordingly. Table III in FIG. 19C presents the eight wigs used in testing, each varying in hair type, volume, and style, selected to evaluate the adaptability of the electrodes in real-world hair conditions. Three wigs are made from real hair (1, 2, and 3), while five are synthetic (4, 5, 6, 7, and 8). Both the thickness and curl level of the wigs are measured, sampling 10 hair strands to determine mean thickness. Wigs are categorized by curl level into three types: Type 1 (straight), Type 2 (slightly curled), and Type 3 (curly). 6 cm hair strands from the top of each wig are selected and the curl of the roots with a curl meter is measured.

To create a standardized testing platform, an artificial skin is developed using water, sodium chloride, and 120-bloom gelatin to evaluate the effectiveness of various electrodes across different hairstyles. According to the Gelatin Manufacturers Institute of America, the bloom value indicates the gelatin's firmness by measuring the force (in grams) required to depress a 0.5-inch diameter piston 4 mm into a gelatin sample made with 6.67% gelatin, 17 hours after preparation at 10° C. This artificial skin formulation is based on the work of Amani et al.

A 3D-printed container with dimensions 15×15×6 cm is used to hold the mixture, which consisted of 540 grams of water, 270 grams of gelatin, and 90 grams of sodium chloride. The mixture is heated in a microwave (Panasonic NN-ST34NB, 900 W output) at medium power for 1 minute to dissolve the gelatin and sodium chloride. After heating, the solution is allowed to cool in a refrigerator at 4° C. for 24 hours, resulting in artificial skin with a stable impedance of 30 kΩ. The required pressing force is measured for the three electrodes to reach the stable impedance 30 kΩ. The experiment setup is illustrated in FIG. 11, and the results for the required force are presented in FIG. 12.

For testing, wigs are placed with various hairstyles on the artificial skin to assess the electrodes' ability to penetrate hair strands effectively. This setup enabled to verify each electrode's performance in simulating real-world hair conditions.

To investigate dose control of conductive gel, the relationship between gliding distance and gel volume dispensed by systematically rolling gel-filled electrodes over artificial skin models equipped with spring-loaded caps is examined. Each electrode is rolled back and forth over a total distance of 6 cm, covering 3 cm in each direction. The dispensed gel volume is measured per cycle using a precision scale. Two types of conductive gel are tested: Signagel Electrode Gel, with a viscosity range of 180,000 to 260,000 cP, and NUPREP Skin Prep Gel gel, with a viscosity of 168,550 cP. The spec of two gels is stated at Table. I in FIG. 19A. Using artificial skin as a simulated scalp substrate, with reference and ground electrodes placed at the corners, electrode resistance on various hair types by placing a wig over the artificial skin are tested.

### C. Experimental Design and Data Processing

15 participants joined this test. Participants are instructed to respond to visual cues, such as pressing a key to continue to the next stage. Each participant is seated on an armed chair at a distance of 70 cm from a 15.6-inch LCD monitor. The experimental procedure consisted of two sessions. In the first session, participants are asked to keep eyes open followed by an eyes-closed session to record the resting-state EEG data. In the second session, participants completed a steady-state visual evoked potential (SSVEP) task, where they are exposed to two flashing light stimuli at frequencies of 10 Hz and 50 Hz. The 10 Hz stimulus is presented first, followed by the 50 Hz stimulus. A 30-second rest period is provided between each task. The entire paradigm is repeated three times, resulting in a total experiment duration of approximately 18 minutes. However, the 50 Hz experiments are not analyzed due to instability caused by hardware constraints during the experiments.

The recruited 15 participants have diverse hair types—8 with straight hair, 5 with slightly wavy hair, and 2 with curly hair—to evaluate the effectiveness of our electrodes. The hair styles of participants mapping relation are shown in Table. II in FIG. 19B. Each participant is tested using three electrode types. The EEG amplifier used CGX Dev Kit with its snap interface connected to the watermill-shaped electrodes. According to the 10-20 International EEG system, electrodes are positioned at Oz, O1, and O2 on the occipital area, with reference at FP1 and ground at FP2. The amplifier sampling rate is set to 500 Hz, event onset of the visual stimulus and the EEG data are recorded by LabStreamLayer. Data processing are first notch-filtered at 60 Hz to reduce line noise and then band-pass filtered between 1 Hz and 55 Hz carried out using MNE-Python/EEGLAB. Data are recorded at both 10 Hz and 50 Hz. Consequently, each participant completed 10 trials using three different types of electrodes, total 30 trials.

### Results: A. Electrode and Its Electrical Response

FIG. 9C shows the coated roller, reservoir with snap-button interface, and spring-loaded cap using the LCD printer. The roller designs for each electrode profile can be found in the previous embodiments or in FIG. 9D.

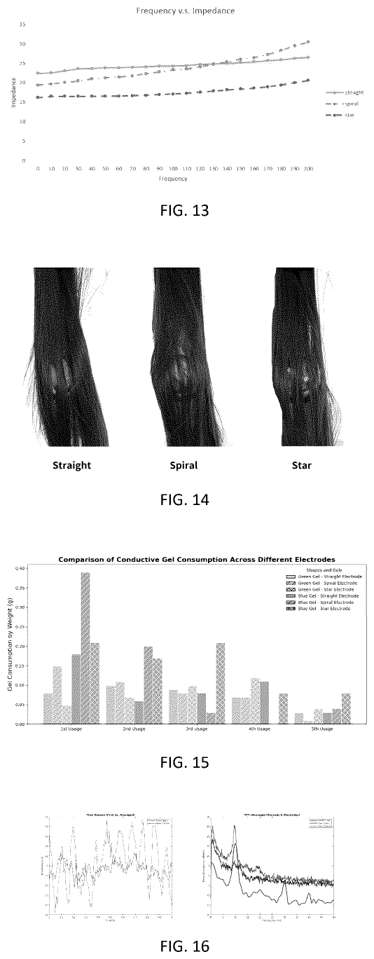

An AAI LCR impedance tester is used to measure electrode impedance response from 0 Hz to 200 Hz with 10 Hz interval. FIG. 13 shows the 5-second averaged impedance response for three electrode profiles. The straight, spiral, and star-shaped profiles show 17.35±1.15 Ω, 32.1±1.77Ω, and 2.66±0.1Ω, respectively. The star-shaped configuration had the lowest and most stable impedance, followed by the straight and spiral profiles.

It is observed that the impedance of the linear roller at 0 Hz is higher than at other frequencies, measuring 19Ω. Below 100 Hz, the impedance gradually decreased with increasing frequency, reaching 15Ω at 90 Hz. However, beyond 100 Hz, the impedance of the roller stabilized at around 17Ω. Overall, the impedance measurements for the three types of rollers demonstrate the reliability of the electrodes across different frequency bands.

### Results: B. Hair-Layer Penetration

Experiments use various styles of wigs, each with at least a 1 cm thick layer of hair. These wigs are placed over artificial skin with electrodes positioned on top to perform pressing and rolling tests. To evaluate the press force required for the proposed electrode across different hair types, an experiment is designed to measure the press force using a digital force gauge. The objective is to achieve an impedance of 30 kΩ with our EEG amplifier and record the required press force. The results, presented in FIG. 12, indicate that only a minimal press force is necessary to maintain user comfort.

During the experiments, the star-shaped electrode demonstrated the best performance in terms of usage smoothness, with only 3 out of 24 tests requiring rolling to reduce impedance, regardless of hairstyle. The straight electrode is the least effective for curly hair, being completely obstructed in 4 instances during tests with curly hair samples (No. 6, 7, and 8). The spiral electrode, although occasionally obstructed, is more effective at penetrating the hair due to its angled design and smaller angle relative to the curls, experiencing blockage only once. The hair penetration image of three electrodes is shown in FIG. 14. Despite these differences, all electrodes successfully reduced impedance when rolling is applied.

### Result: C. Conductive Gel Consumption Rate

FIG. 15 shows the comparison of the gel consumption across different electrodes profiles. After five times rolling cycles, resistance values are recorded, with lower resistance indicating improved scalp contact. All adhesives reach a maximum usage distance of 150 centimeters, after which gel output dropped below 0.01 grams, signaling minimal further application to the scalp. Approximately 0.37 grams of residual gel remain trapped within the roller crevices for each adhesive type and could not be dispensed. As the green gel has a higher viscosity than the blue gel, the blue gel dispenses faster. In addition, FIG. 15 also shows that spiral electrodes consume gel more rapidly than other electrode designs.

### Result: D. EEG Response

The power spectral density (PSD) across three channels (O1, Oz, and O2) from 15 participants with straight, slightly curly, and curly hair is measured. FIG. 16 presents the EEG data in the time, frequency, and amplitude domains for Participant #1, demonstrating successful detection of the 10 Hz component.

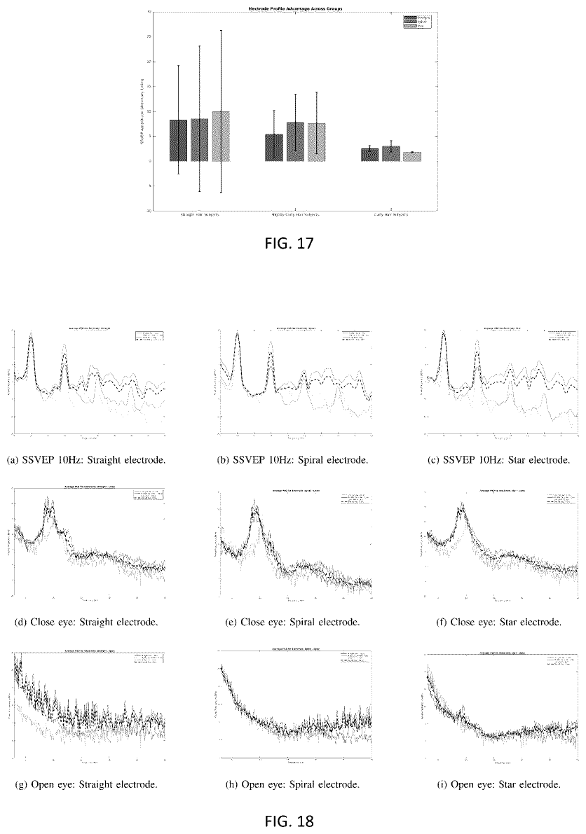

It is also evaluated which proposed electrode profiles are most effective for different hair types. FIG. 17 shows that curly hair poses the greatest measurement challenges.

Our measurements of SSVEP at 10 Hz, under close-eye and open-eye conditions are presented in FIG. 18, which shows that all participants successfully exhibited a response to the 10 Hz SSVEP, as evidenced by a prominent peak at 10 Hz, with a visible second harmonic around 20 Hz in most cases. Overall, all three electrode profiles effectively captured clear SSVEP responses across participants, demonstrating their reliability for detecting 10 Hz SSVEP signals regardless of hair type. The results indicate that alpha peaks are observed for all three electrode profiles across the three channels during the closed-eye session, while these peaks disappeared in the open-eye session.

The design of the electrodes also plays a crucial role in their performance. The original design employed an integrated structure, where the roller and reservoir are printed as a single unit. This design is chosen to simplify the production process and ensure structural stability. Regarding Ag/AgCl coating process, two coating methods are considered: dipping and brushing. Brushing is the preferred method for achieving consistent results.

The straight electrode is suitable for straight hair, the spiral electrode is suitable for slightly curly hair, and the star electrode is suitable for curly hair. The star electrode is suitable for straight hair and slightly curly hair, it offers better user experience and achieves the higher quantitative EEG response.

Without further elaboration, it is believed that one skilled in the art can, based on the above description, utilize the present invention to its fullest extent. The following specific examples are, therefore, to be construed as merely illustrative, and not limitative of the remainder of the disclosure in any way whatsoever.

All references cited herein are incorporated herein by reference in their entirety and for all purposes to the same extent as if each individual reference (e.g., publication or patent or patent application) is specifically and individually indicated to be incorporated by reference in its entirety for all purposes. Other embodiments are within the following claims.

1. A semi-dry electrode assembly, comprising:
a case having a container and an opening; and
an electrode disposed in the container, comprising:
a shaft, rotatably mounted on the case; and
a protrusion structure on the shaft, wherein at least one part of the protrusion structure protrudes through the opening from the container.

2. The assembly of claim 1, wherein the protrusion structure comprises a plurality of protrusions and at least one groove configured to face the opening and a surface of the container alternatively during a rotation of the electrode, the container is configured to contain a conductive material, and the protrusion structure is configured to take out the conductive material from the container to the opening during the rotation of the electrode.

3. The assembly of claim 2, wherein the electrode is configured to pull and dispatch the conductive material on a scalp or a skin during the rotation of the electrode, and at least one of the protrusions is configured to drag the conductive material in the groove or on a surface of the at least one of the protrusions.

4. The assembly of claim 3, wherein the shaft is configured to rotate in the container to cause the conductive material to be carried or dipped in at least one groove by the electrode, the carried or dipped conductive material is applied on the scalp or the skin when the at least one groove faces the opening during the rotation so that the carried or dipped conductive material is delivered from the container to the scalp or the skin.

5. The assembly of claim 3, wherein the shaft is configured to rotate in the container to cause the conductive material to be carried or dipped by at least one of the protrusions, the carried or dipped conductive material is applied on the scalp or the skin when at least one of the protrusions protrudes through opening during the rotation so that the carried or dipped conductive material is delivered from the container to the scalp or the skin.

6. The assembly of claim 2, wherein the protrusions are configured to penetrate a hair layer and reach the scalp or the skin, and the at least one groove is configured to accommodate or comb hairs when the electrode is rolled on the scalp or the skin.

7. The assembly of claim 1, wherein the protrusion structure comprises straight fins.

8. The assembly of claim 1, wherein the protrusion structure comprises spiral-shaped fins.

9. The assembly of claim 1, wherein the protrusion structure comprises tip-shaped fins.

10. The assembly of claim 1, wherein a rotating axis of the shaft is configured to be cross hairs.

11. The assembly of claim 1, wherein at least one of two ends of the shaft is rotatably mounted on the case within the container, and the protrusion structure is between the two ends of the shaft.

12. The assembly of claim 1, further comprising
a cap assembled with the case or disposed atop the container; and
a spring, wherein one end of the spring is mounted on the cap, and the other end of the spring is toward the electrode.

13. The assembly of claim 12, wherein the spring is configured to press an amount of a conductive material in the groove or on a surface of the at least one of the protrusions.

14. The assembly of claim 13, wherein the viscosity of the conductive material is between 200-500000 (cP), and a critical force for the conductive material is between 0.05-0.4 (N).

15. The assembly of claim 13, wherein the case comprises a passage, the spring is arranged along the passage.

16. The assembly of claim 15, wherein the passage is configured to contain a conductive material.

17. The semi-dry electrode assembly of claim 7, further comprising:
a plate on the other end of the spring.

18. The assembly of claim 1, further comprising:
a contact configured to conductively connect a lead to the case.

19. An electroencephalography (EEG) device comprising a plurality of the semi-dry electrode assemblies, wherein the semi-dry electrode assembly comprises:
a case having a container and an opening; and
an electrode disposed in the container, comprising:
a shaft, rotatably mounted on the case; and
a protrusion structure on the shaft, wherein at least one part of the protrusion structure protrudes through the opening from the container.

20. A system for brain-computer interface (BCI) comprising:
an EEG device comprising a plurality of the semi-dry electrode assemblies, wherein the semi-dry electrode assembly comprises:
a case having a container and an opening; and
an electrode disposed in the container, comprising:
a shaft, rotatably mounted on the case; and
a protrusion structure on the shaft, wherein at least one part of the protrusion structure protrudes through the opening from the container;
an amplifier coupled to the semi-dry electrode assemblies of the EEG device; and
a computing device coupled to the amplifier and configured to process signals received by the amplifier as a user input.
